(19) United States
(12) Patent Application Publication
(10) Pub. No.: US 2023/0342706 A1
(43) Pub. Date: Oct. 26, 2023

(54) SYSTEMS AND METHODS FOR MIXED USE RIDESHARE SERVICES

(71) Applicant: Ford Global Technologies, LLC, Dearborn, MI (US)

(72) Inventors: Taylor Hawley, Oak Park, MI (US); Jeremy Lerner, Southfield, MI (US); Mohammad Abouali, Canton, MI (US); Xingping Chen, Troy, MI (US); Danielle Rosenblatt, Madison Heights, MI (US); Scott Huggins, Novi, MI (US)

(73) Assignee: Ford Global Technologies, LLC, Dearborn, MI (US)

(21) Appl. No.: 17/659,858

(22) Filed: Apr. 20, 2022

(51) Int. Cl. G06Q 10/08; G06Q 50/30

(52) U.S. Cl. CPC G06Q 10/08355; G06Q 50/30

(57) ABSTRACT

Systems and methods for mixed use rideshare services are disclosed herein. An example method can include determining a rideshare route for a vehicle, the rideshare route identifying a rider and a package, receiving the rider, receiving the package, the package being received as a first mile portion of package return, and delivering the rider to a first drop off location and the package to a second drop off location.

### BACKGROUND

First and last-mile package delivery can be inefficient. For example, people have issues with the first-mile delivery of packages for initial delivery or returning items. Similar issues exist with respect to online ordering, recycling, package mailing, and so forth. Often, individuals may forego returning items due to the inconvenience of mailing packages or having to return such packages to a specific logistics service or mailing location.

### BRIEF DESCRIPTION OF THE DRAWINGS

A detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example environment in accordance with one or more embodiments of the present disclosure.

FIG. 2 schematically illustrates an example rideshare route for providing rider and first-mile package delivery services in accordance with one or more embodiments of the present disclosure.

FIG. 3 is a flowchart of an example method in accordance with one or more embodiments of the present disclosure.

FIG. 4 is a flowchart of an example method in accordance with one or more embodiments of the present disclosure.

### DETAILED DESCRIPTION

### Overview

The present disclosure pertains to systems and methods for improved first and/or last-mile delivery systems. Rideshare vehicles can be configured to enable rideshare riders (or people who are near rideshare vehicles' routes or stops) to centralize many types of first-mile delivery requirements, such as online retailer returns.

A rideshare vehicle/fleet can be configured such that it can facilitate a certain type of first-mile delivery (e.g., one set of rideshare vehicles can receive returns, one set of rideshare vehicles can receive store drop-offs, one set of rideshare vehicles can receive certain types of household recycling (such as electronics recycling) (especially in areas where localities do not recycle), one set of rideshare vehicles could receive library books, and so forth. Note that some vehicles could receive and transport multiple types of items (depending on their scheduled routes and ability to go to different centralized repositories) if there are multiple compartments available in the vehicle. Rideshare vehicles can be designated in advance to collect certain types of items while traversing their routes in a manner that would optimize the collection effort and rideshare-related functions (e.g., wait time and trip time).

Concurrently, riders can specify their preference for rideshare vehicle(s). That is, when the rider requests the rideshare with an origin location and destination location, they can also specify that they have a certain type of package for which they are seeking to complete the first mile of delivery. A rideshare routing algorithm (executable at the vehicle level or a service provider) can then include this constraint in optimizing the allocation of rideshare vehicles to riders. Riders could also be required to specify a type of package (and the drop off location, if necessary to be specified) in advance (e.g., the night before) so the distribution of rideshare vehicles can be optimized to ensure all packages and types of packages can be collected (perhaps according to other optimization functions, such as minimizing fuel).

Further, the last mile of delivery to rideshare riders can also be completed by utilizing rideshare vehicles. That is when a rideshare rider requests a ride for a future time and they also have a package set to be delivered to them (e.g., by an online retailer), the package can be placed in the trunk of the rideshare vehicle in advance of the ride such that the driver can take it out of the trunk and place it somewhere secure at their origin or destination location.

Rideshare vehicles of the present disclosure could also pick up packages along their routes (especially when there is no rider). For example, if a rideshare vehicle drops off a passenger at a house in a residential area, it may pass in front of a house where a resident has a package they would like picked up. That resident could be informed of the approximate timing of the rideshare vehicle for the pickup (as well as upon arrival of the vehicle) and they could place the item in the rideshare vehicle's trunk (for autonomous or non-autonomous vehicles). Additionally, or alternatively, rideshare drivers (for non-autonomous vehicles) could exit the vehicle to pick up the packages. Rideshare riders could be offered a small discount on their ride in exchange for the small additional time added to their trip by picking up or dropping off packages belonging to others. This discount could be proportional to the added time to the route and limited to a certain percentage of the total trip cost.

The rider could also be offered a discount for physically getting out of the rideshare vehicle to drop off a package at a doorstep (for last-mile delivery) or, for autonomous rideshares, the riders could be offered a discount for physically getting out to pick up a package. Additionally, or alternatively, riders could be prioritized in their routing (e.g., the rider who is willing to physically move packages into or out of the trunk could be prioritized as the first passenger drop off). That is, riders could be offered discounts to help assist this first and last-mile delivery process, especially for autonomous rideshare vehicles. A routing algorithm can prioritize picking up packages when there are no passengers in the vehicle to minimize the discounts given and the additional trip time (provided that picking up the package first does not increase the fuel cost or time significantly).

A mechanism can be included in the vehicle for securing packages that is similar to a one-way dropbox. The mechanism could be placed, for example, in the vehicle's trunk (e.g., the trunk only opens a little bit to not allow the riders to take packages out while allowing them to place a package inside) or in a detachable trailer towed by the vehicle. For a dropbox in the vehicle's trunk, when the trunk is full, the vehicle can be routed to the centralized repository where it could be unloaded before the vehicle continues with rideshare duties (completing the first-mile delivery).

In some instances, the vehicles can tow a detachable trailer that could be dropped off when full at a centralized repository. The vehicle can pick up an empty trailer without requiring unloading at the immediate time of arrival.

Rideshare vehicles could tow trailers (or bring packages in a trunk) in advance of picking up a scheduled (or unscheduled) passenger whose final destination is near a more major (central repository). For example, the rideshare vehicle could generally operate near a regional repository, and when enough packages are collected, could accept a fare from the current area of operation to a more central hub for package collection and bring many packages along with (this part of the process could be called “second-mile delivery”).

Note that riders could be charged a fee for the package pickup provided by the rideshare (e.g., if they have a return that could be dropped off at a locker or other location for free, picked up by a deliver service for a fee, or could be put it in the trunk of a rideshare they were going to take anyway for a different fee). Riders may choose to spend the remuneration on the convenient package pickup, rather than taking a trip to a locker or other drop off/pick up location. This would also apply to the package pickups for people who are not riders.

### Illustrative Embodiments

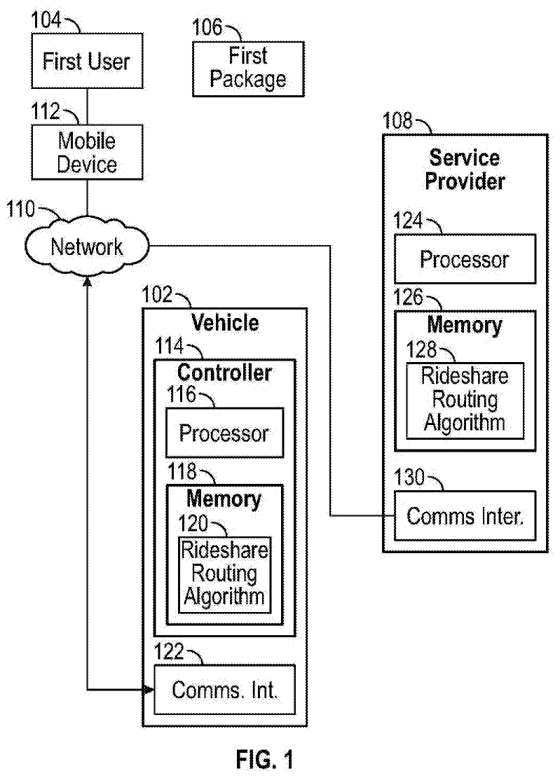

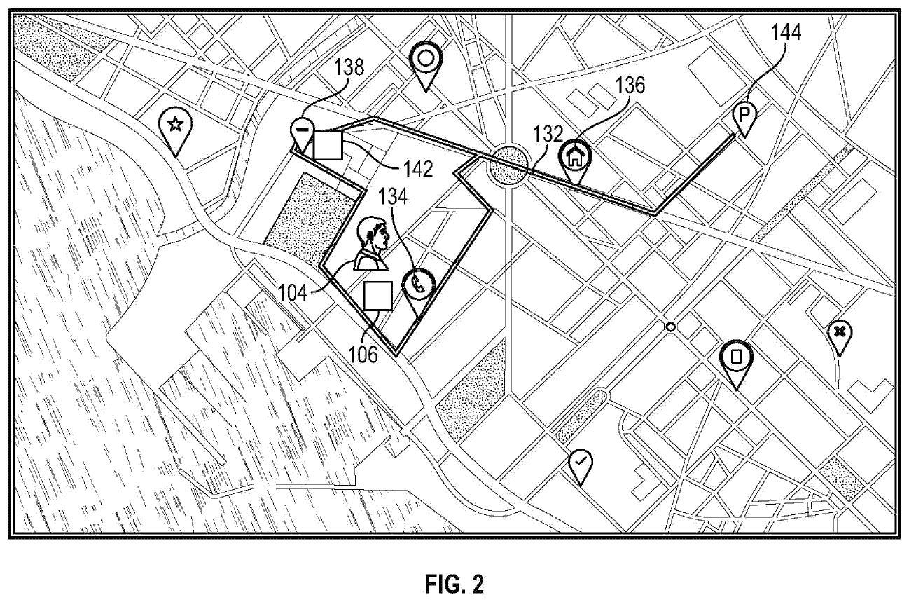

Turning now to the drawings, FIGS. 1 and 2 collectively depict an illustrative architecture in which techniques and structures of the present disclosure may be implemented. The architecture includes a vehicle 102 transporting a first user 104 and a first package 106. The vehicle 102 can include a legacy (e.g., human-driven vehicle) or a semi- or entirely autonomous vehicle.

With respect to autonomous vehicles, the Society of Automotive Engineers (SAE) defines six levels of driving automation ranging from Level 0 (fully manual) to Level 5 (fully autonomous). These levels have been adopted by the U.S. Department of Transportation. Level 0 (L0) vehicles are manually controlled vehicles having no driving-related automation. Level 1 (L1) vehicles incorporate some features, such as cruise control, but a human driver retains control of most driving and maneuvering operations. Level 2 (L2) vehicles are partially automated with certain driving operations such as steering, braking, and lane control being controlled by a vehicle computer. The driver retains some level of control of the vehicle and may override certain operations executed by the vehicle computer. Level 3 (L3) vehicles provide conditional driving automation but are smarter in terms of having an ability to sense a driving environment and certain driving situations. Level 4 (L4) vehicles can operate in a self-driving mode and include features where the vehicle computer takes control during certain types of equipment events. The level of human intervention is very low. Level 5 (L5) vehicles are fully autonomous vehicles that do not involve human participation.

In some instances, the vehicle 102 is a rideshare vehicle that is part of a fleet of vehicles that are managed by a service provider 108. The vehicle 102 and service provider 108 can communicate with one another over a network 110. In some instances, the first user 104 (and other interested parties) can request rideshare and first mile package service from the vehicle 102 using a mobile device 112. The mobile device 112 can install and execute an application that allows the first user 104 to interact with the service provider 108 to request a rideshare and/or first mile package service.

In general, components of the architecture can communicate over the network 110. The network 110 can include combinations of networks. For example, the network 110 may include any one or a combination of multiple different types of networks, such as cellular, cable, the Internet, wireless networks, and other private and/or public networks. The network 110 can include either or both short and long-range wireless networks.

The vehicle 102 can comprise a controller 114 having a processor 116 and a memory 118 for storing executable instructions. The memory 118 can store instructions such as a rideshare routing algorithm 120. When referring to operations of the controller 114 or vehicle 102, this will be understood to include the processor executing instructions, such as the rideshare routing algorithm 120. The vehicle 102 can include a communications interface 122 to transmit and/or receive data over the network 110.

In general, the service provider 108 comprises a processor 124 and a memory 126 for storing executable instructions. For example, the memory 126 can store instructions such as a rideshare routing algorithm 128. When referring to operations of the service provider 108, this will be understood to include the processor executing instructions, such as the rideshare routing algorithm 128. The service provider 108 can include a communications interface 130 to transmit and/or receive data over a network 110.

In some instances, the first user 104 can request a rideshare trip from the service provider 108. The first user 104 can also request the first-mile package service. For example, the first user 104 can request the use of the vehicle 102 to pick up the first package 106. The first user 104 can specify their pick-up location 134. The first user 104 can also identify where the first package 106 is to be delivered. In some instances, the vehicle 102 can be requested to pick up and deliver only the first package 106.

The first user 104 can be delivered to the first drop-off location 136, such as a grocery store, a library, an office building, or any other drop-off location. The first package 106 can be delivered to a second drop-off location 138. The drop-off location for the first package 106 can be selected based on the package type. For example, if the first package 106 is an online return, the drop-off location can be a shipping or logistics company that has contracted with an online retailer that sold the item. Rather than requiring the first user to drive and drop off the package at a drop-off location, the vehicle 102 can complete this task. This is especially advantageous when the first user is traveling to a location that is different from the drop-off location of the package. While at the second location 138, the rider can be asked to pick up a second package 142. Again, the rider can be credited for the task of picking up the second package 142. The second package can be routed to another drop-off location as discussed below.

In addition to picking up the first user 104 and/or the first package 106, the vehicle 102 can be configured to pick up and drop off additional users and/or packages (such as the second package 142) while driving along a rideshare route 132. In one example, after picking up the first user 104, the vehicle can navigate to another pickup location to pick up a second package. In some examples, the first package 106 is not collocated with the first user 104. For example, the first user 104 is picked up at a designated location and the package is near enough to the vehicle 102 or is on the rideshare route and is picked up during transit. The first package 106 may be picked up from a different location. In one example, the first package 106 may be located in a neighborhood where the first user 104 was picked up. The first package 106 could be obtained before or after picking up the first user 104.

As noted above, the service provider 108 can construct a route for the vehicle 102 that maximizes the pickup and drop off of rider(s) and/or package(s). In some instances, the vehicle 102 can collect a pre-determined number of packages before delivering those packages to one or more drop-off locations. In one example, a drop-off location for the second package 142 could be a centralized repository 144. The centralized repository 144 could be operated by a single entity, such as an online retailer or the like. In another example, the centralized repository 144 could include a post office or other location where package types from a plurality of different entities can be placed into additional delivery channels.

A user can be debited or credited a fee for various package-related activities. For example, when picking up a package for first-mile delivery, the user can be charged. In one example, the user can be credited for any delays caused by the vehicle having to stop to pick up or drop off package(s) during a rideshare trip. In some instances, the user can be credited for helping to deliver a package. For example, a user is credited for delivering a package inside a building. The user requested a ride to a particular building. In response, the service provider 108 can request (using the mobile device) the user to deliver a package on behalf of another individual. If accepted, the user can be credited when delivery is attempted or confirmed. In some examples, the service provider 108 can track user debits and credits. The user can confirm delivery or pickup of packages via photographs obtained of a package. These photos can be sent to the service provider 108.

It will be understood that pickup or delivery of some packages may be prioritized based on urgency for delivery (and likely requiring a corresponding increase in the fee collected). For example, a person may be willing to pay more to deliver a package containing important tax documents within an hour to their accountant than a rider would. This could make larger discounts for riders more worthwhile (where the rideshare operator still turns more profit) and even potentially just sending the rideshare vehicle with a high importance package without a passenger, dependent on the increased fee that can be obtained.

As noted above, the service provider 108 can be configured to use the routing algorithm to prioritize picking up packages when there are no passengers in the vehicle to minimize the discounts given and the additional trip time (provided that picking up the package first does not increase the fuel cost or time significantly).

Broadly, the rideshare routing algorithm 128 executed by the service provider 108 (or in some instances the same algorithm used by the vehicle when the service provider is unavailable or is not present) can be optimized across a plurality of parameters or metrics. In some instances, each of these metrics would have its weight in an overall optimization function (e.g., giving an additional five-minute travel time to a repository may be less important than an additional five-minute rideshare trip time).

One example metric for the rideshare routing algorithm includes minimizing rideshare operator cost. Various cost factors may include but are not limited to, fuel, vehicle wear, user debits/credits, and any other factors that affect profitability. Another rideshare routing algorithm optimization metric includes minimizing rideshare rider trip time, which improves customer experience and satisfaction.

Yet other rideshare routing algorithm optimization metrics may include minimizing rideshare rider wait time or maximizing the number (or estimated revenue/profit by weight) of packages to be picked up prior to dropping off at a centralized repository or individual locations.

Another rideshare routing algorithm optimization metric includes minimizing the travel time to the repository (i.e., drop-off packages when the vehicle is already near the repository for a planned route). One example optimization metric includes maximizing the number of package pickup requests fulfilled, while another optimization metric includes minimizing package pickups while passengers are in the vehicle (i.e., minimize discounts given to the riders).

Some optimization metrics involve maintaining space required for riders' luggage (as necessary, or pre-specified). For example, if a rider is going to or from the airport, they may require a vehicle with extra space in the trunk. It will be understood that riders could specify their luggage requirements and that could be included in the ride request.

In one example, the rideshare routing algorithm can minimize package delivery time. For example, certain packages may be required to/incentivized to be delivered within certain time windows, such as when the driver is being diverted from more lucrative passenger pickups, then the package delivery cost would increase.

In one example, the rideshare routing algorithm can determine a distance/travel time from the rider and their desired package drop off location. For example, when routing to a package drop off location takes the driver far away from other pickups or their desired end location, the cost may increase.

Some optimization metrics involve minimizing package pickup cost to rider that can be offered profitably. For example, package pickup and drop off circumstances may cost less than other potential services, such as an individual home pickup. For example, for a pickup, the offerings to a rider could be a free return or a deliver service pickup for cost, so if that rider is going to get in a rideshare vehicle in the near future anyway, the package return should cost less than the potential cost to the rider. Therefore, if the package pickup costs the driver more than the expected/potential cost, then it is not profitable). The cost could further increase based on the increased effort to the driver (e.g., if they must drive away from a planned route or wait to pick up passengers, the opportunity cost is measurable). However, if the extra money from each pickup after centralizing them in the trunk and delivering them to a central repository is greater than the profit a new rider would have provided, then the driver would generally be willing to do this service.

It will be understood that there may be operational differences between pre-scheduled and on-demand rideshare requests. The weighting of metrics surrounding pre-scheduled trips may also differ from those of on-demand trips.

As noted above, the rideshare vehicle can pick up and centralize packages from the rideshare riders directly to allow packages to be centralized (e.g., in the trunk of a rideshare vehicle) for cheaper pickup than a package pickup directly from the riders' homes. Advantageously, there is no increased cost for the rideshare operator for picking up packages from the riders' origin locations in the package pickup process. Further, the packages could be picked up from the rideshare owner along their route (or at their home location) without the rider having to divert from their passenger pickup routing. Additionally, or alternatively, drivers could be paid to drop off the packages they have accumulated at a centralized repository.

The rideshare routing algorithm 128 used by the service provider 108 can implement an objective function for mixed usage of rideshares that transport humans and goods. One example equation includes S=w1*g1+w2*g2+ . . . +w11*g11, where wi=weight for gi. Further, each driver may have a unique set of weights based on historical driving behavior. That is, the service provider 108 and/or vehicle 102 may track driver behaviors and use the same in predictive analytics and route calculation. For example, some drivers may prefer to never drop off packages at a central repository because they have physical difficulty unloading their trunk. For example, a driver may have no privacy concerns with a delivery truck unloading passenger packages from their trunk (that were picked up during their routes). The service provider 108 can implement an analytics hierarchy process to estimate weights for drivers based on a short initial survey (as well as high-level rideshare company priorities, such as minimizing rider wait time). Then, the driver behavior over time can be used to refine the weights for that driver's objective function. For example, a driver may consistently prefer to not do any package pickup outside of their rider directly placing a package in their trunk, the opportunities for package pickup may not be important to that driver. Further, drivers can be clustered based on their weights, for example using principal component analysis, to discover groupings of drivers who have different types of preferences regarding package pickup and delivery options.

In some instances, rideshare companies could be clustered based on their prioritization of the objectives. For example, Company A may prioritize short pickup times but the cost to riders is generally higher than that of Company B.

In yet other examples, the rideshare routing algorithm can implement a true multi-objective function that could be set up, such as S1=g1; S2=g2 . . . SN=gN. A Pareto front can be discovered based on optimizing all (or a subset) of the objectives simultaneously, and the company and driver priorities are used to determine the most important objectives. Then the driver could be provided with a list of some or all the options on the Pareto front (the list could be curated based on high-level company priorities). For example, the company could disallow unnecessarily long rider wait times and then allow drivers to pick the best option for passenger and package pickup combinations that suit them. Essentially, Multi-Criteria Decision Making (MCDM) can be employed to decide which option on the Pareto front is advantageous.

With rideshare vehicle collected data, specifically what the objective values were for a particular package pickup and whether the driver accepted the pickup, a binary classifier could be trained based on different groupings of drivers' data (or even individual drivers) to better predict whether drivers would accept package pickup jobs and whether they would be profitable.

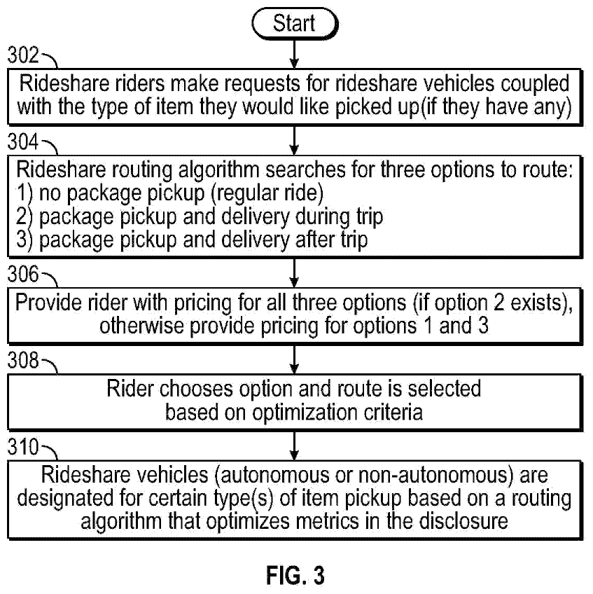

Referring now to FIG. 3, which illustrates an example method of the present disclosure. The method can include a step 302 where a rideshare rider requests a rideshare vehicle and indicates that they have a package for first mile delivery. The rider can identify a size of the package and the delivery service or drop off location for the package. The type of vehicle selected may be based on the package size. For example, a large package may require a van. The type of vehicle selected may be based on the delivery service or drop-off location. For example, if the package needs to be delivered to a local post office, a vehicle assigned to drop off packages at local post offices may be selected. As noted above, some vehicles are agnostic to the delivery service or drop-off location for the package. Also, in some instances, the rider may not have a package to be picked up, but packages may be picked up along the rider's route.

In step 304, the method can include determining route options. For example, three options may be considered where there is no package to be picked up at all, where there is a package to be picked up during the ride, and also where packages can be picked up and delivered after the rideshare trip. The method can include a step 306 of providing the rider with pricing for some or all of these three options, where appropriate or applicable.

Once selected, the method can include a step 308 of receiving from the rider their selections and calculating a rideshare route based on one or more optimization criteria/metrics as described above. In step 310, rideshare vehicles (both autonomous and legacy) can be designated for certain type(s) of item pickup based using a rideshare routing algorithm that optimizes operational metrics. A rideshare vehicle can navigate to a first pick-up location where the rider and the package are at a first pick-up location. The method can include charging the rider for picking up the first-mile portion of the package return.

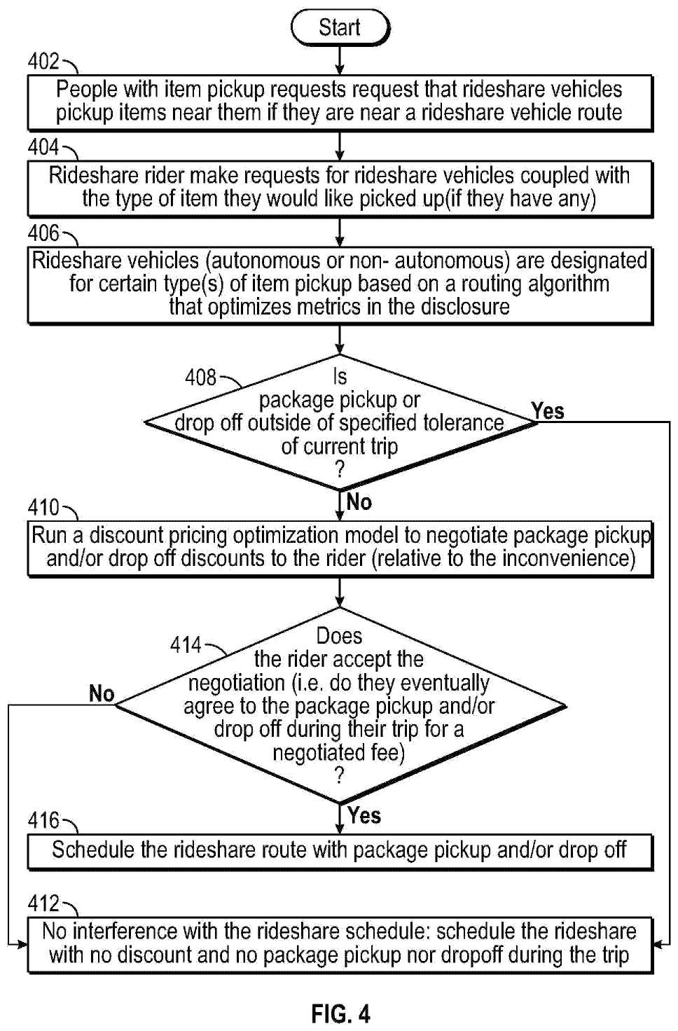

Referring now to FIG. 4, which illustrates an example method of the present disclosure. In step 402, a user with an item for pickup can request that a rideshare vehicle to pick up the item if the rideshare vehicle has a route that passes nearby. In step 404, a rider can make a request for a rideshare vehicle(s) in combination with the type of item they would like to have picked up, such as a package, recycling, and the like. In step 406, rideshare vehicles can be designated for certain type(s) of item pickup based using a rideshare routing algorithm that optimizes operational metrics. In step 408, a determination is made as to whether the package pickup or drop-off is outside of a specified tolerance of a current trip. For example, a distance threshold can be used, such as one block, one mile, or another distance value. If the pickup or drop off is outside of a specified tolerance of a current trip, the method can include a step 410 of executing a discount pricing optimization model to negotiate package pickup and/or drop off discounts to the rider, which can be proportional to the impact to the rider. The impact can be determined relative to the time delay in some examples.

On the other hand, if the pickup or drop-off is not outside of a specified tolerance of a current trip, the method can include a step 412 of scheduling a rideshare with no discount and no package pickup or drop off during the trip. This step is selected in some instances when no interference should occur with the rideshare schedule, based on the use of the optimization metrics and/or a request from the rider that they do not want to have packages picked up along their ride route. When the package or item that is picked up does not belong to the rider, the method can include the rideshare vehicle navigating to a second location to pick up the package, as well as delivering a second package to a recipient along the rideshare route. The recipient could be another person or a drop-off location of a delivery service, as examples.

In step 414, a determination is made as to whether the rider will accept the negotiated price increase or decrease. That is, does the rider agree to the package pick up and/or drop off during their trip for a negotiated credit or reduction in rideshare cost. If so, the method can include a step 41 If so, the method can include a step 416 of scheduling the rideshare with package pickup and/or drop off. In some instances, the rider can be credited for delivering the package as well. Stated otherwise, the method can include applying a discount for the rider for the time required to deliver the package and/or when the rider delivers the package at the drop-off. The discount can be proportional to added time for the rideshare route and is limited to a percentage of the total trip cost of the rideshare route.

Some components described herein can be implemented as a computer system, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system includes a processor or multiple processor(s) (e.g., a central processing unit (CPU), a graphics processing unit (GPU), or both), and a main memory and static memory, which communicate with each other via a bus. The computer system may further include a video display (e.g., a liquid crystal display (LCD)). The computer system may also include an alpha-numeric input device(s) (e.g., a keyboard), a cursor control device (e.g., a mouse), a voice recognition or biometric verification unit (not shown), a drive unit (also referred to as disk drive unit), a signal generation device (e.g., a speaker), and a network interface device. The computer system may further include a data encryption module (not shown) to encrypt data.

The drive unit includes a computer or machine-readable medium on which is stored one or more sets of instructions and data structures (e.g., instructions) embodying or utilizing any one or more of the methodologies or functions described herein. The instructions may also reside, completely or at least partially, within the main memory and/or within the processor(s) during execution thereof by the computer system. The main memory and the processor(s) may also constitute machine-readable media.

The instructions may further be transmitted or received over a network via the network interface device utilizing any one of a number of well-known transfer protocols (e.g., Hyper Text Transfer Protocol (HTTP)). While the machine-readable medium is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

The components provided in the computer system are those typically found in computer systems that may be suitable for use with embodiments of the present disclosure and are intended to represent a broad category of such computer components that are well known in the art. Thus, the computer system can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computer system may be implemented as a cloud-based computing environment, such as a virtual machine operating within a computing cloud. In other embodiments, the computer system may itself include a cloud-based computing environment, where the functionalities of the computer system 1 are executed in a distributed fashion. Thus, the computer system, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer system, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The detailed description is, therefore, not to be taken in a limiting sense, and the scope is defined by the appended claims and their equivalents.

Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching.

What is claimed is:

1. A method comprising:
determining a rideshare route for a vehicle, the rideshare route identifying a rider and a package;
receiving the rider;
receiving the package, the package being received as a first-mile portion of package return; and
delivering the rider to a first drop-off location and the package to a second drop-off location.

2. The method according to claim 1, further comprising:
navigating to a first pick up location, the rider and the package being at the first pick up location; and
charging the rider for picking up the first-mile portion of package return.

3. The method according to claim 1, further comprising navigating to a second location to pick up the package, the package belonging to another individual.

4. The method according to claim 1, further comprising delivering a second package to a recipient along the rideshare route.

5. The method according to claim 4, further comprising applying a discount for the rider for time required to deliver the second package or when the rider delivers the second package.

6. The method according to claim 5, wherein the discount is proportional to added time for the rideshare route and is limited to a percentage of a total trip cost of the rideshare route.

7. The method according to claim 1, further comprising prioritizing pick up of packages when no riders have requested rideshare service.

8. The method according to claim 1, further comprising selecting the vehicle based on a package type of the package.

9. The method according to claim 1, wherein the second drop-off location is a centralized repository.

10. A vehicle comprising:
a processor; and
a memory for storing instructions, the processor executing the instructions to:
determine a rideshare route for the vehicle, the rideshare route identifying a rider and a package;
receive the rider;
receive the package, the package being received as a first-mile portion of package return; and
deliver the rider to a first drop-off location and the package to a second drop-off location.

11. The vehicle according to claim 10, further comprising a plurality of compartments, each of the plurality of compartments being associated with a package type or package receiver, the package being placed into one of the plurality of compartments.

12. The vehicle according to claim 11, wherein the processor is configured to:
navigate to a first pick up location, the rider and the package being at the first pick up location; and
charge the rider for picking up the first-mile portion of package return.

13. The vehicle according to claim 10, wherein the processor is configured to navigate to a second location to pick up the package, the package belonging to another individual.

14. The vehicle according to claim 10, wherein the processor is configured to deliver a second package to a recipient along the rideshare route.

15. The vehicle according to claim 14, wherein the processor is configured to apply a discount for the rider for time required to deliver the second package or when the rider delivers the second package.

16. The vehicle according to claim 15, wherein the discount is proportional to added time for the rideshare route and is limited to a percentage of a total trip cost of the rideshare route.

17. The vehicle according to claim 10, wherein the processor is configured to prioritize pick up of packages when no riders have requested rideshare service.

18. The vehicle according to claim 10, wherein the processor is configured to select the vehicle based on a package type of the package.

19. The vehicle according to claim 11, wherein the second drop-off location is a centralized repository.

20. The vehicle according to claim 10, wherein the processor is configured to prioritize delivery of the package to the second drop-off location before the rider based on a delivery urgency level for the package.
